(19) United States
(12) Patent Application Publication
(10) Pub. No.: US 2016/0148430 A1
(43) Pub. Date: May 26, 2016

(54) MOBILE DEVICE, OPERATING METHOD FOR MODIFYING 3D MODEL IN AR, AND NON-TRANSITORY COMPUTER READABLE STORAGE MEDIUM FOR STORING OPERATING METHOD

(71) Applicant: INISTITUTE FOR INFORMATIOM INDUSTRY, Taipei (TW)

(72) Inventors: Jung-Hsuan LIN, Taipei City (TW); Shih-Yao WEI, Taipei City (TW); Rong-Sheng WANG, Taipei City (TW); Shih-Chun CHOU, Taipei City (TW)

(21) Appl. No.: 14/715,558

(22) Filed: May 18, 2015

(30) Foreign Application Priority Data
Nov. 20, 2014 (TW) 103140286

(51) Int. Cl. G06T 19/00; G06T 19/20; G06T 17/00

(52) U.S. Cl. CPC G06T 19/006; G06T 17/00; G06T 19/20

(57) ABSTRACT

An operating method for modifying a 3D model in Augmented Reality (AR) on a mobile device includes performing, through the mobile device, a mobile application, wherein the mobile application provides a user interface configured to present a 3D environment image and a 3D model in AR, provide a modification function for adjusting one of a size, an angle, and a location of the 3D model in AR in the 3D environment image, and provide a confirm function for recording parameter data corresponding to the adjusted one of the size, the angle, and the location of the 3D model in AR; and transmitting the parameter data to a server to serve as updated parameter data corresponding to a AR application, so as to allow the server to update parameter data corresponding to the AR application in the mobile device according to the updated parameter data in the server.

### RELATED APPLICATIONS

This application claims priority to Taiwan Application Serial Number 103140286, filed Nov. 20, 2014, which is herein incorporated by reference.

### FIELD

The present disclosure relates to a mobile device, an operating method thereof, and a non-transitory computer readable medium. More particularly, the present disclosure relates to a mobile device capable of modifying a 3D model in Augmented Reality (AR), an operating method for modifying a 3D model in AR on a mobile device, and a non-transitory computer readable medium for storing a computer program configured to execute an operating method for modifying a 3D AR object on a mobile device.

### BACKGROUND

With advances in technology, Augmented Reality (AR) technology is widely used in our daily lives.

AR is a technique of synthesizing a virtual object with a real-word environment image in real time and providing the synthesized result to a user. By using AR, people's lives can be enriched.

World patent application publication No. 2013023705 A1 discloses a method for building a model in AR. In addition, United State patent application publication No. 20140043359 A1 discloses a method for improving the features in AR.

However, by applying the methods in these applications, it is still difficult for a designer to accurately synthesize a virtual object with a real-world environment image, since a designer is not able to directly modify a model in AR on the electrical device (e.g., mobile device) which executes an AR software. As a result, it is inconvenient for establishing and modifying an AR.

### SUMMARY

One aspect of the present disclosure is related to an operating method for modifying a 3D model in Augmented Reality (AR) on a mobile device. In accordance with one embodiment of the present disclosure, the operating method includes performing, through the mobile device, a mobile application, wherein the mobile application provides a user interface configured to present a 3D environment image and a 3D model in AR, provide a modification function for adjusting one of a size, an angle, and a location of the 3D model in AR in the 3D environment image, and provide a confirm function for recording parameter data corresponding to the adjusted one of the size, the angle, and the location of the 3D model in AR; and transmitting the parameter data to a server to serve as updated parameter data corresponding to a AR application, so as to allow the server to update parameter data corresponding to the AR application in the mobile device according to the updated parameter data in the server.

In accordance with one embodiment of the present disclosure, the operating method further includes providing, through the user interface, a recording function to record a process of adjusting one of the size, the angle, and the location of the 3D model in AR in video form for generating recording data; and transmitting, through the mobile device, the recording data to the server.

In accordance with one embodiment of the present disclosure, the parameter data is used to determine at least one of a relative size, a rotated angle, a relative location, and an animation of the 3D model in AR in the 3D environment image of the AR application.

In accordance with one embodiment of the present disclosure, the operating method further includes capturing, through a capturing component, a real-world environment to generate the 3D environment image; acquiring a relative location between the capturing component and the real-world environment; and when an editing command corresponding to the 3D model in AR is received through the user interface, determining an event corresponding to the 3D model in AR according to the relative location.

In accordance with one embodiment of the present disclosure, the operating method further includes providing, through the user interface, an animation-establishing function. The animation-establishing function includes when a drag gesture corresponding to the 3D model in AR is received, moving the 3D model in AR according to the drag gesture; and recording a process of moving the 3D model in AR, to serve as a user-defined animation of the 3D model in AR.

Another aspect of the present disclosure is related to a mobile device capable of modifying a 3D model in AR. In accordance with one embodiment of the present disclosure, the mobile device includes a network component, and a processing component. The processing component is configured for performing a mobile application, wherein the mobile application provides a user interface configured to present a 3D environment image and a 3D model in AR, provide a modification function for adjusting one of a size, an angle, and a location of the 3D model in AR in the 3D environment image, and provide a confirm function for recording parameter data corresponding to the adjusted one of the size, the angle, and the location of the 3D model in AR; and transmitting, through the network component, the parameter data to a server to serve as updated parameter data corresponding to a AR application, so as to allow the server to update parameter data corresponding to the AR application in the mobile device according to the updated parameter data in the server.

In accordance with one embodiment of the present disclosure, the user interface is further configured for providing a recording function to record a process of adjusting one of the size, the angle, and the location of the 3D model in AR in video form for generating recording data. The processing component is further configured for transmitting, through the network component, the recording data to the server.

In accordance with one embodiment of the present disclosure, the parameter data is used to determine at least one of a relative size, a rotated angle, a relative location, and an animation of the 3D model in AR in the 3D environment image of the AR application.

In accordance with one embodiment of the present disclosure, the mobile device further includes a capturing component. The processing component is further configured for capturing, through the capturing component, a real-world environment to generate the 3D environment image; acquiring a relative location between the capturing component and the real-world environment; and when an editing command corresponding to the 3D model in AR is received through the user interface, determining an event corresponding to the 3D model in AR according to the relative location.

In accordance with one embodiment of the present disclosure, the user interface further provides an animation-establishing function. The animation-establishing function includes when a drag gesture corresponding to the 3D model in AR is received, moving the 3D model in AR according to the drag gesture, and recording a process of moving the 3D model in AR through the processing component, to serve as a user-defined animation of the 3D model in AR.

Another aspect of the present disclosure is related to a non-transitory computer readable medium for storing a computer program configured to execute an operating method for modifying a 3D AR object on a mobile device. In accordance with one embodiment of the present disclosure, the operating method includes performing, through the mobile device, a mobile application, wherein the mobile application provides a user interface configured to present a 3D environment image and a 3D model in AR, provide a modification function for adjusting one of a size, an angle, and a location of the 3D model in AR in the 3D environment image, and provide a confirm function for recording parameter data corresponding to the adjusted one of the size, the angle, and the location of the 3D model in AR; and transmitting the parameter data to a server to serve as updated parameter data corresponding to a AR application, so as to allow the server to update parameter data corresponding to the AR application in the mobile device according to the updated parameter data in the server.

In accordance with one embodiment of the present disclosure, the operating method further includes providing, through the user interface, a recording function to record a process of adjusting one of the size, the angle, and the location of the 3D model in AR in video form for generating recording data; and transmitting, through the mobile device, the recording data to the server.

In accordance with one embodiment of the present disclosure, the parameter data is used to determine at least one of a relative size, a rotated angle, a relative location, and an animation of the 3D model in AR in the 3D environment image of the AR application.

In accordance with one embodiment of the present disclosure, the operating method further includes capturing, through a capturing component, a real-world environment to generate the 3D environment image; acquiring a relative location between the capturing component and the real-world environment; and when an editing command corresponding to the 3D model in AR is received through the user interface, determining an event corresponding to the 3D model in AR according to the relative location.

In accordance with one embodiment of the present disclosure, the operating method further includes providing, through the user interface, an animation-establishing function. The animation-establishing function includes when a drag gesture corresponding to the 3D model in AR is received, moving the 3D model in AR according to the drag gesture; and recording a process of moving the 3D model in AR, to serve as a user-defined animation of the 3D model in AR.

Through utilizing one embodiment described above, a designer can in real-time edit the model in AR in a manner along with 3D environment image.

### BRIEF DESCRIPTION OF THE DRAWINGS

FIG. 1 is a schematic diagram of a mobile device according to one embodiment of the present disclosure.

FIG. 2 illustrates a relationship between the mobile device and a real-world environment according to one embodiment of the present disclosure.

FIG. 3A illustrates a user interface according to one operative example of the present disclosure.

FIG. 3B illustrates a user interface according to one operative example of the present disclosure.

FIG. 4 illustrates a user interface according to one operative example of the present disclosure.

FIG. 5 illustrates a user interface according to one operative example of the present disclosure.

FIG. 6 illustrates a mobile device and a real-word environment according to one operative example of the present disclosure.

FIG. 7 is a flowchart of an operating method of a mobile device according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, when an element is referred to as being “connected” or “electrically connected” to another element, it can be directly connected to the other element or intervening elements may be present. In contrast, when an element is referred to as being “directly connected” to another element, there are no intervening elements present. Moreover, “electrically connect” or “connect” can further refer to the interoperation or interaction between two or more elements.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, unless otherwise defined, all terms (including technical and scientific terms) have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any element in a claim that does not explicitly state “means for” performing a specified function, or “step for” performing a specific function, is not to be interpreted as a “means” or “step” clause as specified in 35 U.S.C. §112(f). In particular, the use of “step” of in the claims herein is not intended to invoke the provisions of 35 U.S.C. §112(f).

One aspect of the present disclosure is related to a mobile device. The mobile device can display a 3D environment image and 3D model in AR. To facilitate the description to follow, a tablet computer or a smart phone will be taken as examples in the following paragraphs. However, the present disclosure is not limited to this embodiment.

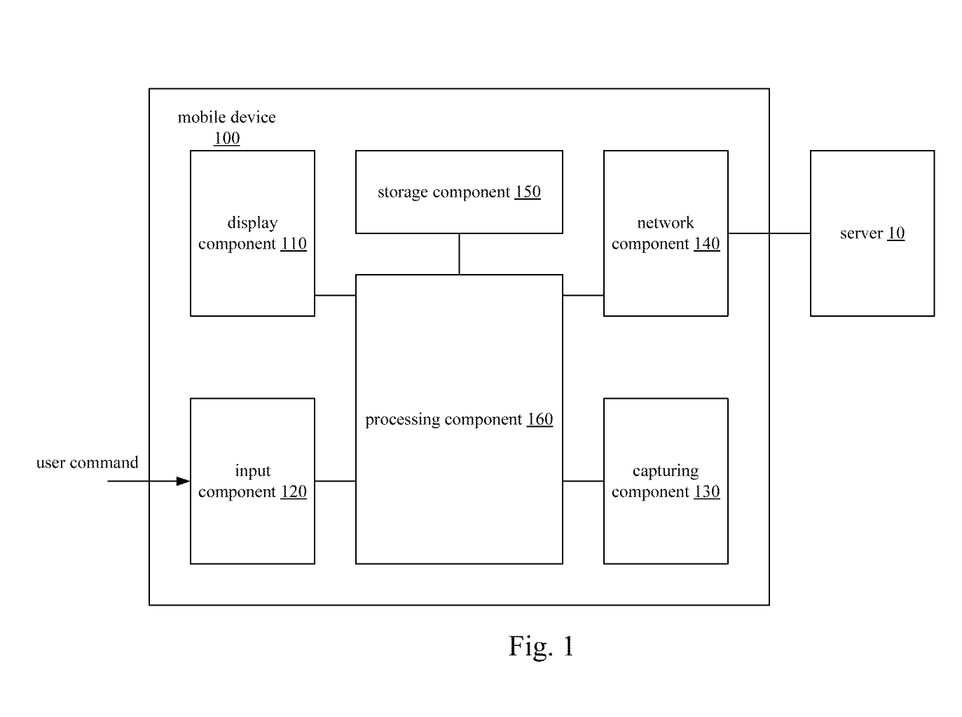

Reference is made to FIG. 1, which is a schematic diagram of a mobile device 100 according to one embodiment of the present disclosure. In one embodiment, the mobile device 100 includes a network component 140 and a processing component 160. In this embodiment, the processing component 160 may be electrically connected to the network component 140. The network component 140 is configured to provide a connection between the mobile device 100 and a remote server via a wireless communication network. The network component 140 may be realized by using, for example, a wireless integrated circuit. The processing component 160 can execute a mobile application (such as APP) to provide a user interface configured to present a 3D environment image and a 3D model in AR, provide a modification function for a user to adjust a size, an angle, or a location of the 3D model in AR in the 3D environment image. The mobile application also provides a confirm function for recording parameter data corresponding to the adjusted size, angle, or location of the 3D model in AR, and transmits the parameter data to the remote server to serve as updated parameter data. The remote server can update parameter data of the mobile device 100 (or parameter data of another mobile device with an AR application to display the 3D model in AR and the 3D environment image) according to the updated parameter data.

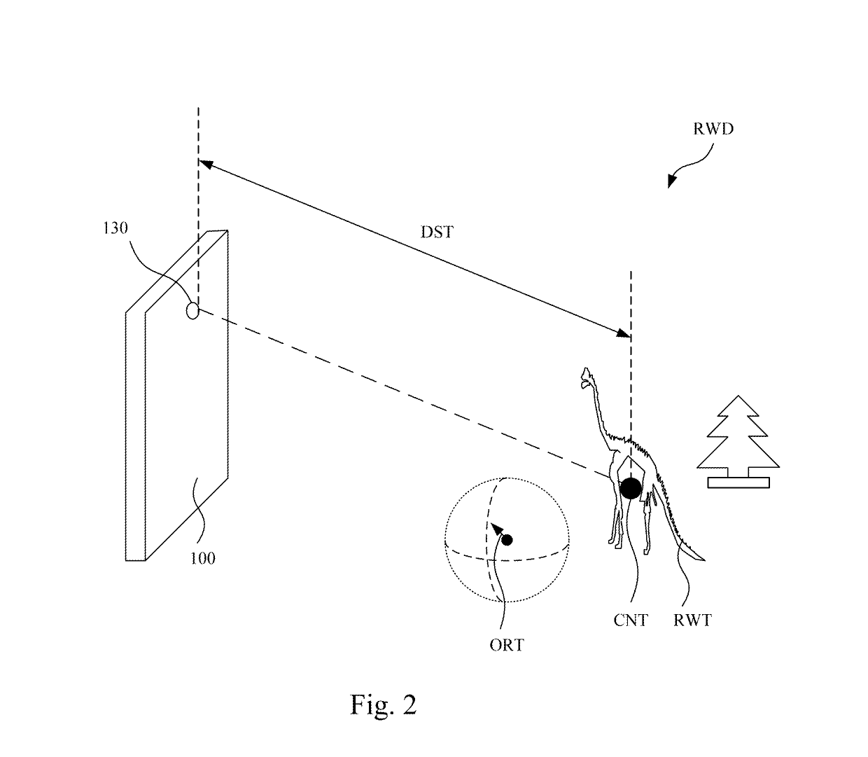

Reference is now made to both FIGS. 1 and 2. FIG. 1 is a schematic diagram of a mobile device 100 according to one embodiment of the present disclosure. FIG. 2 illustrates a relationship between the mobile device 100 and a real-world environment RWD according to one embodiment of the present disclosure. In this embodiment, the mobile device 100 includes a display component 110, an input component 120, a capturing component 130, a network component 140, a storage component 150, and a processing component 160. In one embodiment, the processing component 160 can separately and electrically connected to the display component 110, the input component 120, the capturing component 130, the network component 140, and the storage component 150.

In one embodiment, the display component 110 can be realized by, for example, a liquid crystal display (LCD), an active matrix organic light emitting diode (AMOLED) display, a touch display, or another suitable display component. The input component 120 can be realized by, for example, a touch panel or another suitable input component. The capturing component 130 can be realized by, for example, lens, a camera, a video camera, or another relevant component. The network component 140 can be realized by, for example, a wireless communication integrated circuit. The storage component 150 can be realized by, for example, a memory, a portable storage media, or another suitable storage device. The processing component 160 can be realized by, for example, a central processor, a microprocessor, or another suitable processing component. In one embodiment, the input component 120 and the display component 110 can be integrated as single component (e.g., a touch display panel).

In this embodiment, the display component 110 may be configured to display an image thereon. The input component 120 may be configured to receive a user command from a user. The capturing component 130 may be configured to capture a real-word image RWD. The network component 140 may be configured to transmit data with a server 10 via a network (not shown). The storage component 150 may be configured to store data. The processing component 160 may be configured to execute a mobile application to allow a user to modify an AR model displayed on the display component 110 by the input component 120 in real-time.

Details of the mobile device 100 in one embodiment will be described in the paragraphs below. However, the present disclosure is not limited to such an embodiment.

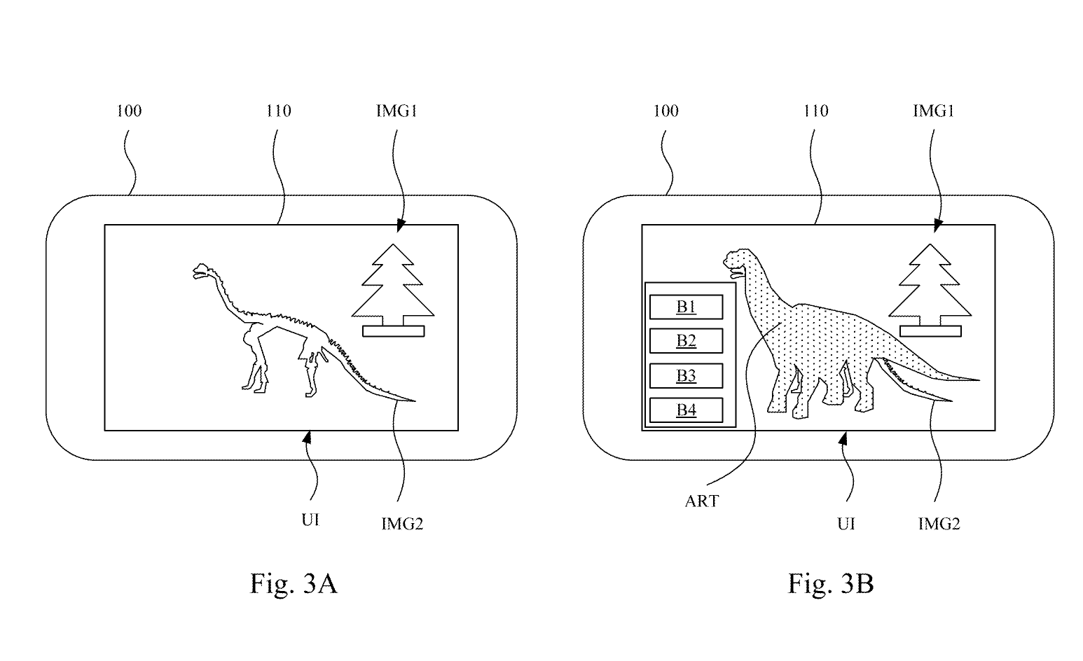

Particular reference is made to FIG. 2. In one embodiment of the present disclosure, the processing component 160 may capture an image of the real-world environment RWD by utilizing the capturing component 130 to obtain a 3D environment image (e.g., a 3D environment image IMG1 shown in FIG. 3A).

In this embodiment, a real-world object RWT is presented in the real-world environment RWD. A real-world object image (e.g., a real-world object image IMG2 shown in FIG. 3A) is presented in the 3D environment image. The processing component 160 may acquire a plurality of features FTR of the image IMG2 of the real-world object RWT, and search a corresponding 3D model (e.g., the 3D model ART shown in FIG. 3B) in AR within a database DBS. In one embodiment, the database DBS may be located in the storage component 150, but is not limited in this regard. In another embodiment, the database DBS may be located in the server 10.

In this embodiment, the processing component 160 may acquire a location relationship between the capturing component 130 of the mobile device 100 and the real-world environment RWD according to the features and the corresponding data in the database DBS. More particular, in this embodiment, the processing component 160 may acquire a distance DST between the capturing component 130 and the real-world object RWT, and a relative angle ANG between the capturing component 130 and an orientation ORT of the real-world object RWT according to the features and the corresponding data in the database DBS. In one embodiment, the distance DST may be calculated by utilizing the capturing component 130 and a center point CNT of the real-world object RWT, but is not limited in this regard. In one embodiment, the distance DST and the relative angle ANG can be recorded by using a transformation matrix TRM, but is not limited in this regard.

Particular reference is made to FIGS. 3A and 3B. In this embodiment, the processing component 160 may execute a mobile application. The mobile application provide a user interface UI to present a 3D environment image IMG1 corresponding to the real-world environment RWD on the display component 110 (as shown in FIG. 3A). A real-word object image IMG2 corresponding to the real-world object RWT in the real-world environment RWD is presented in the 3D environment image IMG1. The processing component 160 may simultaneously display the 3D environment image IMG1 corresponding to the real-world environment RWD and a 3D model ART in AR corresponding to the real-word object image IMG2 in the user interface UI on the display component 110 (as shown in FIG. 3B).

In one embodiment, the storage component 150 may store parameter data. The parameter data corresponds to at least one of a size corresponding to the real-word object image IMG2, an angle corresponding to the real-word object image IMG2, a location corresponding to the real-word object image IMG2, and an animation of the 3D model ART in AR. The processing component 160 may display the 3D model ART in AR on the display component 110 according to the parameter data. That is, the parameter data is used to determine at least one of a relative size, a rotated angle, and a relative location of the 3D model ART relative to the real-word object image IMG2 and an animation of the 3D model ART in the 3D environment image IMG1 of the AR application.

In one embodiment, the user interface UI may provide a modification function to adjust at least one of the size, the angle, and the location of the 3D model ART in the 3D environment image IMG1.

For example, a user may click a button B1 to adjust the size of the 3D model ART in AR relative to the size of the real-word object image IMG2 in the 3D environment image IMG1. A user may click a button B2 to adjust the angle of the 3D model ART in AR relative to the angle of the real-word object image IMG2 in the 3D environment image IMG1. A user may click a button B3 to adjust the location of the 3D model ART in AR relative to the location of the real-word object image IMG2 in the 3D environment image IMG1. A user may click a button B4 to determine the processing component 160 to execute an animation clip located at which period of a default animation corresponding to the 3D model ART in the 3D environment image IMG1 (e.g., the processing component 160 may execute an animation clip located at the fifth to fifteenth second of the default animation with a length of 100 seconds).

In addition, in this embodiment, the user interface UI may provide a confirm function for recording parameter data corresponding to the adjusted size, angle, location, and animation of the 3D model ART in AR. In one embodiment, the parameter data may be stored in the storage component 150.

After the parameter data corresponding to the adjusted size, angle, location, and animation of the 3D model ART in AR are recorded, the processing component 160 may transmit the parameter data to the server 10 to serve as updated parameter data, such that a designer who is away from this real-world environment RWD is able to load the updated parameter data to modify the 3D model ART according to the updated parameter data, and further update the parameter data in the server 10.

Additionally, in each time the processing component 160 execute the mobile application, the processing component 160 may download the updated parameter data (usually the newest parameter data) from the server 10 to update the parameter data in the mobile device 100. In other words, the server 10 may update the parameter data in the mobile device 100 according to the updated parameter therein.

Through such operations, a designer can in real-time edit the model in AR in a manner along with 3D environment image.

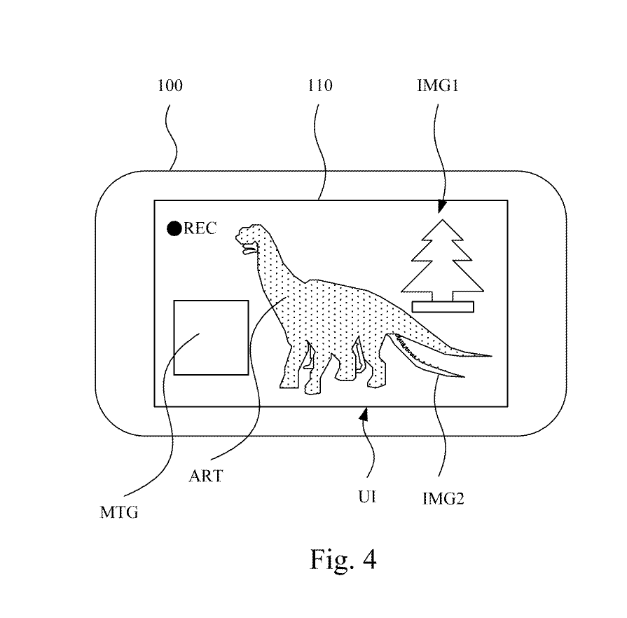

Reference is made to FIG. 4. In one embodiment, the user interface UI may provide a recording function to record a process of adjusting at least one of the size, the angle, and the location of the 3D model in video form for generating recording data. After the recording data is generated, the processing component 160 may transmit the recording data to the server 10 via the network component 140.

In one embodiment, the user interface UI may provide a tag function to insert a modification tag MTG in the recording data. The modification tag MTG may be visually presented when the recording data is displayed. In such a manner, a designer who is away from this real-world environment RWD is able to modify the 3D model ART according to the modification tag MTG in the recording data.

In one embodiment, during the processing component 160 transmits the recording data to the server 10 via the network component 140, the processing component 160 may also transmit some information, such as parameter data of the size, the angle, the location, and the animation of the 3D model ART, the relative location between the capture component 130 and the real-world environment RWD, and the material of the 3D model ART in the recording process to the server 10, such that a designer who is away from this real-world environment RWD is able to acquire relevant parameter data in the recording process.

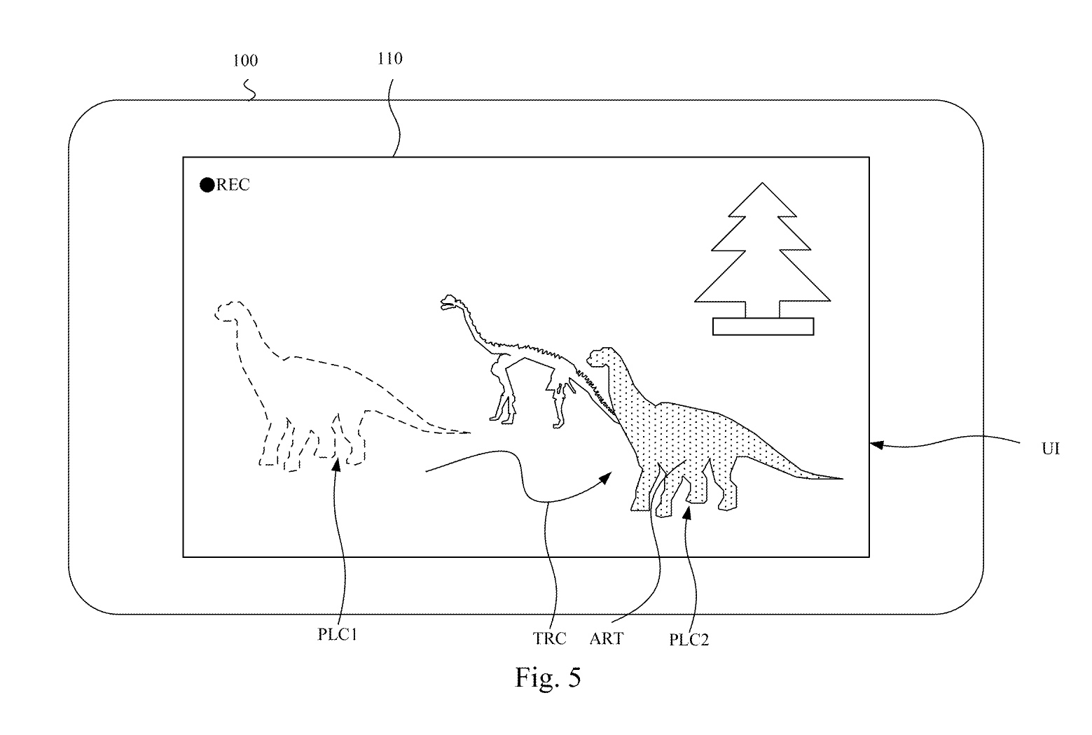

Reference is made to FIG. 5. In one embodiment, the user interface UI may provide an animation-establishing function. The animation-establishing function includes when a drag gesture corresponding to the 3D model ART in AR is received by the processing component 160 via the input component 120, the processing component 160 moves the 3D model ART in AR on the display component 110 according to the drag gesture; and the processing component 160 records a process of moving the 3D model ART in AR, to serve as a user-defined animation of the 3D model ART in AR.

For example, in one embodiment, under a condition that a user drag the 3D model ART from a first place PLC1 to a second place PLC2 along the trace TRC, the processing component 160 records the process of moving the 3D model ART along the trace TRC, to serve as a user-defined animation of the 3D model ART.

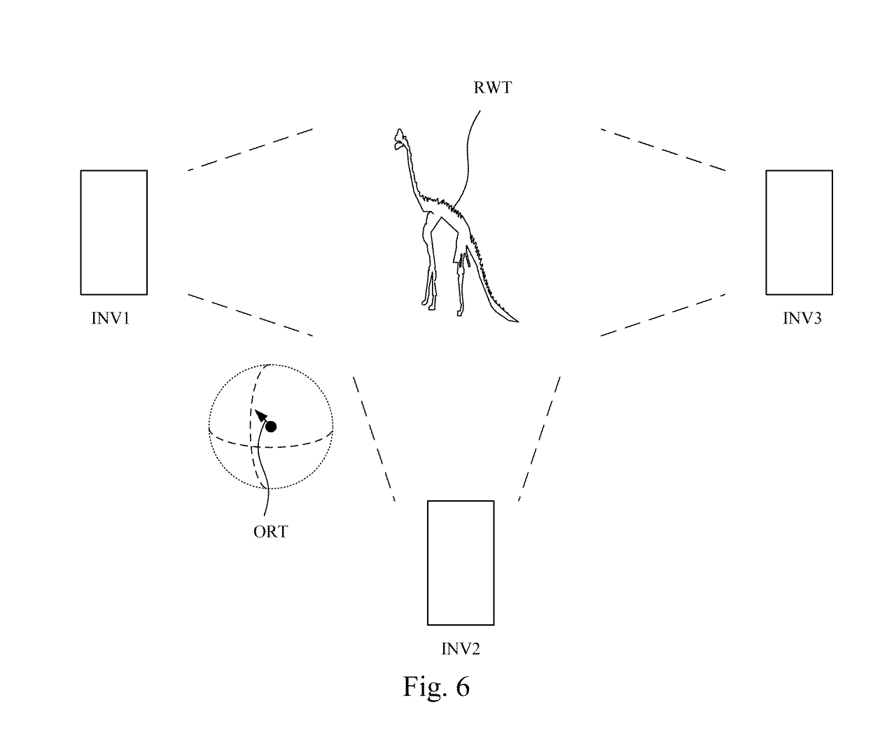

Reference is made to FIG. 6. In one embodiment, the user interface UI may provide an event editing function. When the processing component 160 receive an editing command corresponding to the 3D model ART via the user interface UI, the processing component 160 may determine an event corresponding to the 3D model ART according to the relative location between the capturing component 130 of the mobile device and the real-world environment RWD.

For example, when a relative angle between the capturing component 130 and the orientation ORT of the real-world object RWT is within a first angle range INV1 (e.g., 1-120 degree), the processing component 160 may execute a first event corresponding to the 3D model ART in AR (e.g., execute an animation clip located at the tenth to twentieth second of the default animation of the 3D model ART). When a relative angle between the capturing component 130 and the orientation ORT of the real-world object RWT is within a second angle range INV2 (e.g., 121-240 degree), the processing component 160 may execute a second event corresponding to the 3D model ART in AR (e.g., execute an animation clip located at the twentieth to thirtieth second of the default animation of the 3D model ART). When a relative angle between the capturing component 130 and the orientation ORT of the real-world object RWT is within a third angle range INV3 (e.g., 241-360 degree), the processing component 160 may execute a third event corresponding to the 3D model ART in AR (e.g., magnify the size of the 3D model ART in AR 1.2 times). The first angle range INV1, the second angle range INV2, and the third angle range INV3 are different from each other. The first event, the second event, and the third event are different from each other.

Through such operations, the presentation of the 3D model ART in AR can have an expanded number of applications.

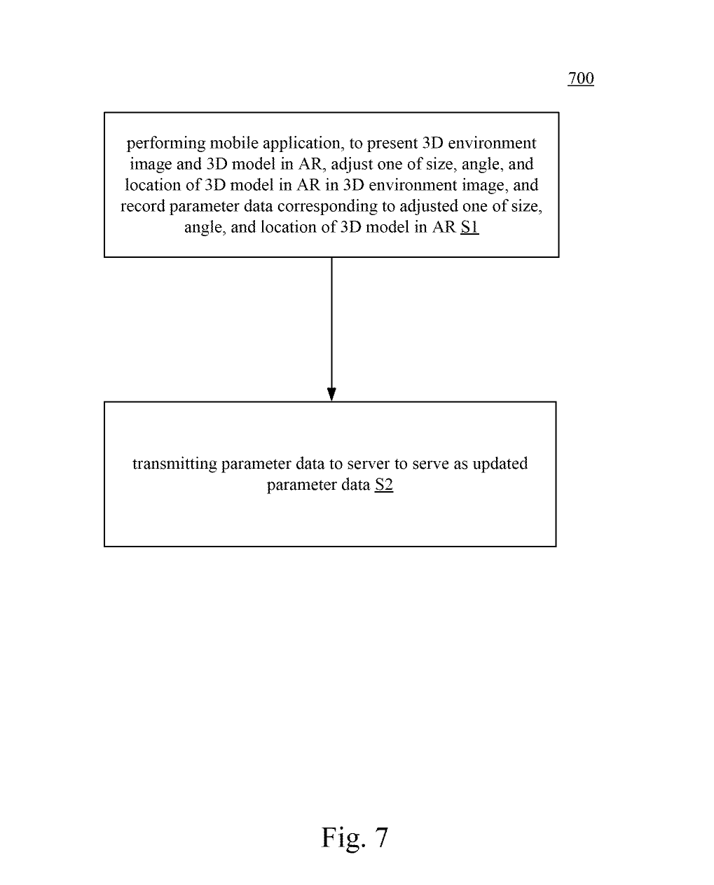

FIG. 7 is a flowchart of an operating method 700 of a mobile device according to one embodiment of the present disclosure. The operating method 700 can be applied to a mobile device having a structure that is the same as or similar to the structure shown in FIG. 1. To simplify the description below, in the following paragraphs, the embodiment shown in FIG. 1 will be used as an example to describe the operating method 700 according to an embodiment of the present disclosure. However, the present disclosure is not limited to application to the embodiment shown in FIG. 1.

It should be noted that, the operating method 700 can be implemented by using the mobile device 100 in the embodiment described above, or can be implemented as a computer program stored in a non-transitory computer readable medium to be read for controlling a computer or an electronic device to execute the operating method 700. The computer program can be stored in a non-transitory computer readable medium such as a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

In addition, it should be noted that, in the steps of the following method 300, no particular sequence is required unless otherwise specified. Moreover, the following steps also may be performed simultaneously or the execution times thereof may at least partially overlap.

Furthermore, the steps of the following method 300 may be added, replaced, and/or eliminated as appropriate, in accordance with various embodiments of the present disclosure.

In this embodiment, the operating method 700 includes the steps below.

In step S1, a mobile application is performed to provides a user interface to present a 3D environment image IMG1 and a 3D model ART in AR, provide a modification function for adjusting one of a size, an angle, and a location of the 3D model ART in AR in the 3D environment image IMG1, and provide a confirm function for recording parameter data corresponding to the adjusted one of the size, the angle, and the location of the 3D model ART in AR.

In step S2, the parameter data is transmitted to the server 10 by the network component 140 of the mobile device 100 to serve as updated parameter data, so as to allow the server 10 to update parameter data corresponding to the AR application in the mobile device 100 according to the updated parameter data in the server.

It should be noted that detail of the operating method 700 can be ascertained by the embodiments in FIGS. 1-6, and a description in this regard will not be repeated herein.

Although the present disclosure has been described in considerable detail with reference to certain embodiments thereof, other embodiments are possible. Therefore, the scope of the appended claims should not be limited to the description of the embodiments contained herein.

What is claimed is:

1. An operating method for modifying a 3D model in Augmented Reality (AR) on a mobile device comprising:
performing, through the mobile device, a mobile application, wherein the mobile application provides a user interface configured to present a 3D environment image and a 3D model in AR, provide a modification function for adjusting one of a size, an angle, and a location of the 3D model in AR in the 3D environment image, and provide a confirm function for recording parameter data corresponding to the adjusted one of the size, the angle, and the location of the 3D model in AR; and
transmitting the parameter data to a server to serve as updated parameter data corresponding to a AR application, so as to allow the server to update parameter data corresponding to the AR application in the mobile device according to the updated parameter data in the server.

2. The operating method as claimed in claim 1 further comprising:
providing, through the user interface, a recording function to record a process of adjusting one of the size, the angle, and the location of the 3D model in AR in video form for generating recording data; and
transmitting, through the mobile device, the recording data to the server.

3. The operating method as claimed in claim 1, wherein the parameter data is used to determine at least one of a relative size, a rotated angle, a relative location, and an animation of the 3D model in AR in the 3D environment image of the AR application.

4. The operating method as claimed in claim 1 further comprising:
capturing, through a capturing component, a real-world environment to generate the 3D environment image;
acquiring a relative location between the capturing component and the real-world environment; and
when an editing command corresponding to the 3D model in AR is received through the user interface, determining an event corresponding to the 3D model in AR according to the relative location.

5. The operating method as claimed in claim 1 further comprising:
providing, through the user interface, an animation-establishing function, and the animation-establishing function comprises:
when a drag gesture corresponding to the 3D model in AR is received, moving the 3D model in AR according to the drag gesture; and
recording a process of moving the 3D model in AR, to serve as a user-defined animation of the 3D model in AR.

6. A mobile device capable of modifying a 3D model in AR comprises:
a network component; and
a processing component configured for:
performing a mobile application, wherein the mobile application provides a user interface configured to present a 3D environment image and a 3D model in AR, provide a modification function for adjusting one of a size, an angle, and a location of the 3D model in AR in the 3D environment image, and provide a confirm function for recording parameter data corresponding to the adjusted one of the size, the angle, and the location of the 3D model in AR; and
transmitting, through the network component, the parameter data to a server to serve as updated parameter data corresponding to a AR application, so as to allow the server to update parameter data corresponding to the AR application in the mobile device according to the updated parameter data in the server.

7. The mobile device as claimed in claim 6, wherein the user interface is further configured for providing a recording function to record a process of adjusting one of the size, the angle, and the location of the 3D model in AR in video form for generating recording data; and
the processing component is further configured for transmitting, through the network component, the recording data to the server.

8. The mobile device as claimed in claim 6, wherein the parameter data is used to determine at least one of a relative size, a rotated angle, a relative location, and an animation of the 3D model in AR in the 3D environment image of the AR application.

9. The mobile device as claimed in claim 6, wherein the mobile device further comprises a capturing component, the processing component is further configured for:
capturing, through the capturing component, a real-world environment to generate the 3D environment image;
acquiring a relative location between the capturing component and the real-world environment; and
when an editing command corresponding to the 3D model in AR is received through the user interface, determining an event corresponding to the 3D model in AR according to the relative location.

10. The mobile device as claimed in claim 6, wherein the user interface further provides an animation-establishing function, and the animation-establishing function comprises:
when a drag gesture corresponding to the 3D model in AR is received, moving the 3D model in AR according to the drag gesture; and
recording a process of moving the 3D model in AR through the processing component, to serve as a user-defined animation of the 3D model in AR.

11. A non-transitory computer readable storage medium for storing a computer program configured to execute an operating method for modifying a 3D AR object on a mobile device, the operating method comprising:
performing, through the mobile device, a mobile application, wherein the mobile application provides a user interface configured to present a 3D environment image and a 3D model in AR, provide a modification function for adjusting one of a size, an angle, and a location of the 3D model in AR in the 3D environment image, and provide a confirm function for recording parameter data corresponding to the adjusted one of the size, the angle, and the location of the 3D model in AR; and
transmitting the parameter data to a server to serve as updated parameter data corresponding to a AR application, so as to allow the server to update parameter data corresponding to the AR application in the mobile device according to the updated parameter data in the server.

12. The non-transitory computer readable storage medium as claimed in claim 11, wherein the operating method further comprising:
providing, through the user interface, a recording function to record a process of adjusting one of the size, the angle, and the location of the 3D model in AR in video form for generating recording data; and
transmitting, through the mobile device, the recording data to the server.

13. The non-transitory computer readable storage medium as claimed in claim 11, wherein the parameter data is used to determine at least one of a relative size, a rotated angle, a relative location, and an animation of the 3D model in AR in the 3D environment image of the AR application.

14. The non-transitory computer readable storage medium as claimed in claim 11, wherein the operating method further comprising:
capturing, through a capturing component, a real-world environment to generate the 3D environment image;
acquiring a relative location between the capturing component and the real-world environment; and
when an editing command corresponding to the 3D model in AR is received through the user interface, determining an event corresponding to the 3D model in AR according to the relative location.

15. The non-transitory computer readable storage medium as claimed in claim 11, wherein the operating method further comprising:
providing, through the user interface, an animation-establishing function, and the animation-establishing function comprises:
when a drag gesture corresponding to the 3D model in AR is received, moving the 3D model in AR according to the drag gesture; and
recording a process of moving the 3D model in AR, to serve as a user-defined animation of the 3D model in AR.
